(19) United States
(12) Patent Application Publication
(10) Pub. No.: US 2003/0065579 A1
(43) Pub. Date: Apr. 3, 2003

(54) Computer system for customizing a fuel dispenser

(75) Inventor: Han Smits, Beumingen (NL)

Correspondence Address: RANDALL J. KNUTH P.C., 3510-A STELLHORN ROAD, FORT WAYNE, IN, 46815-4631, US

(73) Assignee: Tokheim Corporation

(21) Appl. No.: 10/040,141

(22) Filed: Jan. 2, 2002

Related U.S. Application Data
(60) Provisional application No. 60/325,805, filed on Sep. 28, 2001.

(51) Int. Cl. G06F 17/60

(52) U.S. Cl. 705/26

(57) ABSTRACT

A computer with a database of options for designing a fuel dispenser for the construction of the fuel dispenser. The options are selected and the customized fuel dispenser is displayed. Once the customization is completed, the fuel dispenser is saved with a computer. The design of the fuel dispenser is transferred to a location for construction.

### BACKGROUND OF THE INVENTION

1. Field of the Invention

The present invention relates to a remote computer system used for developing and designing a fuel dispenser prior to the construction of the fuel dispenser.

2. Description of the Related Art

The use of computer databases has been used in a wide variety of fields to assist the user in making choices on a particular item, e.g., the use of computer databases to design cabinets, wall-coverings, floral arrangements, as well as furniture. A problem in the sales and marketing of fuel dispensers is that there is no system that allows a customer to use a database to design the outward appearance or livery of a fuel dispenser and have that design transferred to a manufacturing facility to have the fuel dispenser constructed. The present invention solves this problem.

### SUMMARY OF THE INVENTION

The present invention comprises, in one form thereof, a method of utilizing a computer system with a database of fuel dispenser options and features to design a fuel dispenser prior to manufacturing of the fuel dispenser. The options are selected from the database using a selection means for the design of the fuel dispenser. The options, as well as an image of the customized fuel dispenser, are displayed on a display means and once the customized fuel dispenser design is completed, the fuel dispenser design is saved with the computer. The design is transferred to a location wherein the customized fuel dispenser is manufactured.

The present invention comprises, in another form thereof, a computer system with a database of fuel dispenser options to design a fuel dispenser prior to manufacture of the fuel dispenser. The selection means is used to choose options from the database for the design of the fuel dispenser. The options, as well as the customized fuel dispenser, are viewed using a display means. The customized fuel dispenser design is saved with a computer once the design of the customized fuel dispenser is completed and the design is transferred using a transfer means to a location where the customized fuel dispenser is manufactured.

The present invention comprises, in yet another form thereof, a computer system with a database of fuel dispenser options to design a fuel dispenser prior to the manufacture of the fuel dispenser. A selection means is used to choose options from the database for the design of the fuel dispenser. The options, as well as an image of the customized fuel dispenser, are viewed using a display means. Once the design of the customized fuel dispenser is completed, the design is transferred to a location using a transfer means wherein the customized fuel dispenser is manufactured.

An advantage of the present invention is that the customer is able to customize every surface and/or side of the fuel dispenser using a computer and a display means. The design is sent to a location so that the fuel dispenser can be manufactured according to the customer's specifications.

Another advantage of the present invention is that the software is simple enough that someone, such as a salesperson, with a non-technical background could easily select, construct and order the manufacture of a custom fuel dispenser.

A further advantage of the present invention is that changes to the design of the customized fuel dispenser are very simple. The fuel dispenser customized design can be retrieved from the computer, modifications can be made to the design of the fuel dispenser, and the fuel dispenser design can be saved or transferred to a location for manufacturing.

### BRIEF DESCRIPTION OF THE DRAWINGS

The above-mentioned and other features and advantages of this invention, and the manner of attaining them, will become more apparent and the invention will be better understood by reference to the following description of an embodiment of the invention taken in conjunction with the accompanying drawings, wherein:

FIG. 1 is a flowchart of one embodiment of the present invention;

FIG. 2 is a diagrammatic view of the transfer means transferring the design to a factory;

FIG. 3 is a diagrammatic rendering of an example screen for selecting options to customize fuel dispenser;

Corresponding reference characters indicate corresponding parts throughout the several views. The exemplification set out herein illustrates one preferred embodiment of the invention, in one form, and such exemplification is not to be construed as limiting the scope of the invention in any manner.

### DETAILED DESCRIPTION OF THE INVENTION

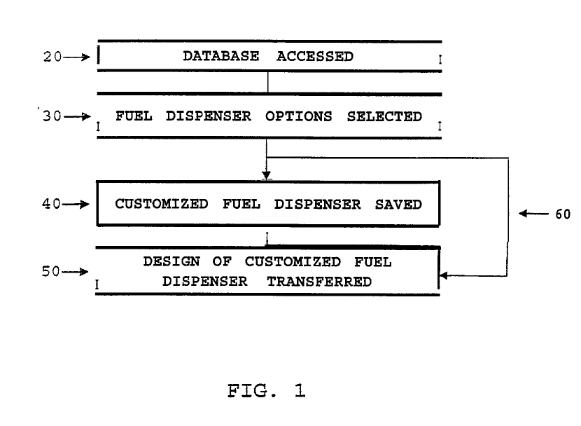

Referring now to the drawings, and particularly to FIG. 1, there is shown a computer system and application, also described as a livery system, with a database of fuel dispenser options to design a fuel dispenser prior to construction or manufacture of the fuel dispenser.

The database is preferably based on the relational database model but it can be based on either the hierarchical model or the network model. The type of model used depends upon the processor speed as well as the memory available on the computer running the livery program. The livery system is written in Visual Basic. Other programming languages can alternatively be used as well. The database is SQL driven and is located at a central file server. The SQL database is copied to a Microsoft Access database located at the sites where the designing of the fuel dispenser is done by the customer. The database can be created using other database development programs as well.

A computer system with a database of fuel dispenser options is accessed (20). The database can be stored on a hard disk, floppy disk or on a compact disk as well as other storage mediums. Also, the database can be with a remote computer or an on-site computer. Options from the database are selected (30) using the mouse or the keyboard with the computer system. The ideal computer system is an IBM compatible computer running the Windows 98 operating system having a minimum of a 400 mhz processor, but other types of computer systems can be used.

Once the computer system with a database of fuel dispenser options is accessed (20), a screen appears on the display means. By choosing “open”, the livery request screen appears. This screen has all requests that need livery and requests which already are completed and are sent to the factory. From this screen, the select button is chosen to construct a new fuel dispenser. Once the select button is chosen, an unedited fuel dispenser image appears on the display means. At this point, options can be added to each side and/or surface of the fuel dispenser. The options can be selected for each side and/or surface of the fuel dispenser but for ease of description, the sides of a rectangular fuel dispenser will be described.

One of the options that can be selected for each side of the fuel dispenser includes the color of the fuel dispenser and the color of the options to add to the fuel dispenser. A palette of colors are available to select from when customizing the fuel dispenser. A specific palette of colors used by a particular fuel provider can be stored in the database as well. The gloss of the color selected from the palette can also be selected. Also, other options that can be selected are the types of paint for the fuel dispenser, indicia and stickers to be placed on the fuel dispenser, patterns to be placed on the fuel dispenser, and products to be dispensed from the fuel dispenser. The stickers can be designed or can be chosen from the stickers stored in the database. Also, the stickers can be accessed from the database and edited. The size of the sticker can also be selected. The fuel dispenser can be manufactured with the sticker already on the fuel dispenser or the stickers can be created and/or edited and placed in the box to be shipped with the fuel dispenser so that the customer can apply the sticker to the fuel dispenser at a later time.

Other options include hose quantity, hose orientation, and the style of the hose for the fuel dispenser. Also, the fuel dispenser type can be selected as single sided or double sided. Each of the options, including the image of the fuel dispenser display, can be positioned anywhere on the image of the fuel dispenser. Once an option is positioned on the image of the fuel dispenser, the position of that option can be changed as many times as necessary without re-starting the design process.

The options, as well as the image of the customized fuel dispenser, are displayed on the display means. The display means displays the current price of the particular option, as well as the total cost of the customized fuel dispenser as each option is selected. The options can be selected using pull-down menus and pop-up menus.

The display means displays traffic light shaped images for each side of the fuel dispenser. To customize a particular side of the fuel dispenser, the corresponding traffic light shaped image may be selected or the side of the fuel dispenser to be customized may be selected using the mouse to point the cursor to the side of the fuel dispenser to be customized and choosing that side using the mouse button; In one embodiment of the present invention, each traffic light can be used to indicate whether a minimal number of mandatory options has been chosen for each side of the fuel dispenser. If the traffic light displays a red light for a particular side of the fuel dispenser, the red light indicates that not all of the mandatory features for that side of the fuel dispenser have been selected. Upon selecting all of the mandatory features needed for that side of the fuel dispenser, the traffic light will display a green light for that side of the fuel dispenser. If all traffic lights display a green light the design can be transferred (50) to a factory for construction of the fuel dispenser.

The fuel dispenser may have surfaces to be customized in addition to each side of the fuel dispenser. Some surfaces that can be customized would be the panels inside the fuel dispenser column or the bottom of the raceway. The number of surfaces on the fuel dispenser to be customized depends upon the structure of the fuel dispenser. There is a corresponding traffic light for every surface that can be customized on the fuel dispenser.

The “add sticker” button is used to add a sticker to the fuel dispenser, without having to position the sticker. The “add sticker” button can add the sticker to the fuel dispenser at the time of manufacture or can create the sticker and the sticker will be placed in the box used to ship the fuel dispenser so that the customer can apply the sticker at a later time. Also, the “first part” button, “next” button, “previous” button and “last part” buttons can be selected to cycle through each of the options available for the fuel dispenser. The “edit” button is used to edit the livery of the customized fuel dispenser. The “gallery” button keeps records of parts which have been previously completed. The “gallery” button allows selection of these previously completed parts. The “part info” button displays additional attributes of the part such as whether stickering is possible on the part, not possible on that part, or mandatory for that part. The “unfinished” button cycles through the sides of the fuel dispenser which still require customization. The “options” button allows for selection of standard parts from a predefined list of parts.

Once the design of the customized fuel dispenser is completed, the design can be saved (40) with a computer and then transferred (50) to a location where the customized fuel dispenser is constructed or the design can be transferred (50) directly to a location for construction without saving (40) the design of the customized fuel dispenser (60). If the design is saved (40) with the computer, the design can be saved to a hard drive, floppy drive, compact disk drive, a remote system or any other storage medium. To transfer the design to the location for construction, the “approve order” button can be selected or the approve order option from the pull-down menu can be selected. Also, the design can be transferred (50) using a modem, but other transferring means can be used as well. The database is designed to transfer the order to a particular factory but a different factory can be selected by the user of the database or the selected factory may forward the order to another factory for load balancing. This feature allows a factory that is behind in processing its orders to transfer the order to a factory that is more equipped to quickly process the order.

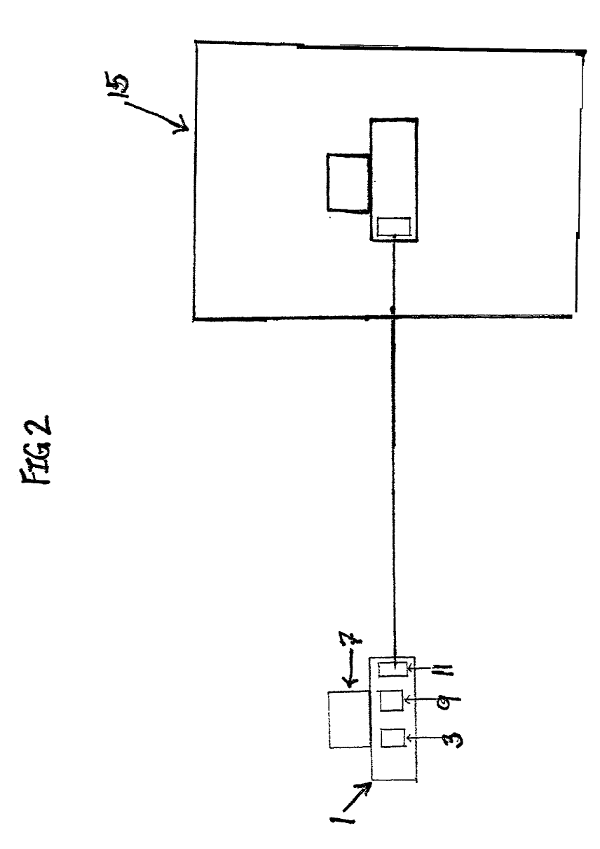

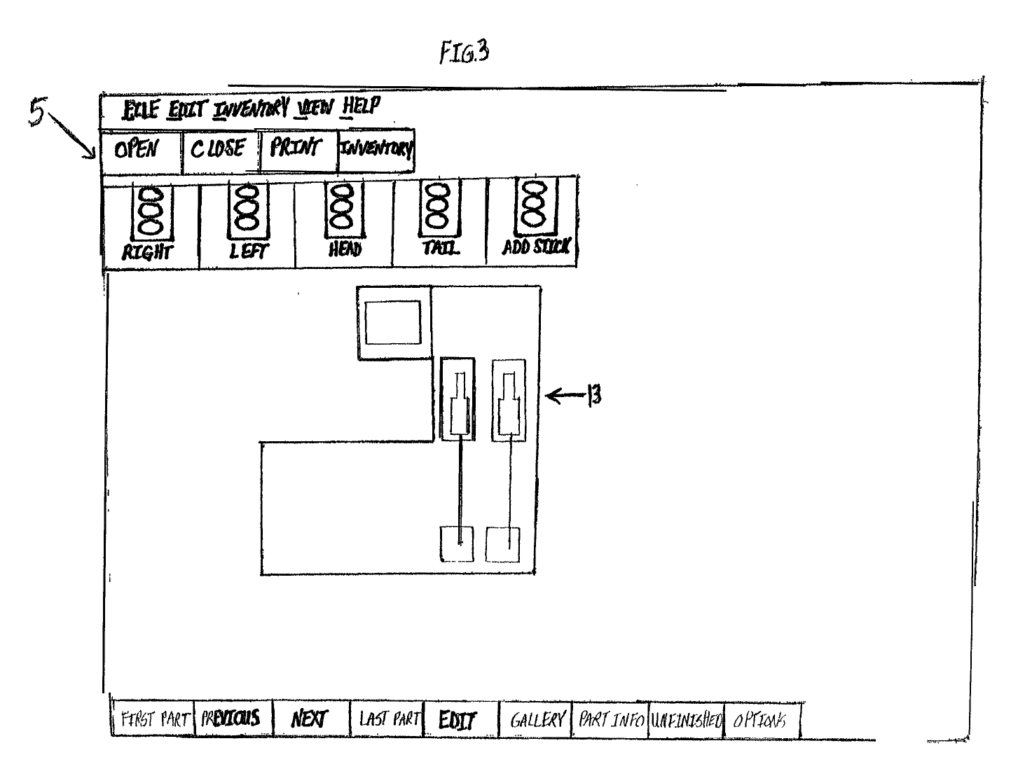

Another form of the present invention, as shown in FIGS. 2 and 3, is a system to design and customize a fuel dispenser 13. A computer 1 with a database 3 of fuel dispenser options and features is accessed. A selection means 5 is used, such as a mouse or keyboard with the computer 1, to choose options for the customization of the fuel dispenser 13. The options consist of, but are not limited to, colors for the fuel dispenser, types of paint for the fuel dispenser, indicia, stickers and patterns to be placed on the fuel dispenser, products to be dispensed from the fuel dispenser, and hose quantity, as well as hose orientation and style of the hose. A fuel dispenser can be either single sided or double sided. Each and every side of fuel dispenser 13 must have an option selected for it, otherwise a default value will be entered for that side of the fuel dispenser 13 before the design can be transferred to a factory for construction of the fuel dispenser. A display means 7 is used to display the options, as well as realtime images of the fuel dispenser 13 as it is being designed. A saving means 9 allows for the design of fuel dispenser 13 to be electronically saved so that the changes can easily be made to the design at a later time, if necessary. A transfer means 11 is used to send the design to a location so that the design for the customized fuel dispenser 13 can be used to construct the fuel dispenser 13.

Another form of the present invention eliminates the saving means from the system. A computer 1 with a database 3 of fuel dispenser options is accessed. A selection means 5, such as the mouse or the keyboard with computer 1, is used to choose options for the customization of the fuel dispenser 13.

The options consist of, but are not limited to, colors for the fuel dispenser, types of paint for the fuel dispenser, indicia, stickers and patterns to be placed on the fuel dispenser, products to be dispensed from the fuel dispenser, and hose quantity, as well as hose orientation and style of the hose. A fuel dispenser can be either single sided or double sided. Each and every side of fuel dispenser 13 must have an option selected for it, otherwise a default value will be entered for that side of the fuel dispenser 13 before the design can be transferred to a factory for construction of the fuel dispenser. A display means 7 is used to display the options, as well as realtime images of the fuel dispenser 13 as it is being designed. Once the design of the fuel dispenser 13 is completed, a transfer means 11 is used to send the design to a location 15 that the design for the customized fuel dispenser 13 can be used to construct the customized fuel dispenser 13.

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A system to customize a fuel dispenser comprising:
a computer;
a database of fuel dispenser options with said computer;
a selection means for selecting said fuel dispenser options from said database of said fuel dispenser options to create a customized fuel dispenser;
a display means for displaying said fuel dispenser options;
a saving means for saving data with said computer comprising said customized fuel dispenser; and
a transfer means for transferring data with said computer comprising said customized fuel dispenser to a location for constructing said customized fuel dispenser.

2. The system of claim 1, wherein said customized fuel dispenser has at least one side and said fuel dispenser options are selected for each of said at least one side of said customized fuel dispenser.

3. The system of claim 1, wherein said fuel dispenser options are displayed as pull-down menus and pop-up menus.

4. The system of claim 1, wherein said fuel dispenser options include different colors for said customized fuel dispenser.

5. The system of claim 1, wherein said fuel dispenser options include designs for said customized fuel dispenser.

6. The system of claim 1, wherein said fuel dispenser options include different types of paint for said customized fuel dispenser.

7. The system of claim 1, wherein said fuel dispenser options include hose quantity.

8. The system of claim 1, wherein said fuel dispenser options include products to be dispensed from said customized fuel dispenser.

9. The system of claim 1, wherein said fuel dispenser options include positioning of said display means on said customized fuel dispenser.

10. The system of claim 1, wherein said transfer means is a modem.

11. The system of claim 1, wherein said display means displays current prices of said fuel dispenser options.

12. The system of claim 1, wherein said display means displays total cost of said customized fuel dispenser as said fuel dispensing options are selected.

13. The system of claim 1, wherein said fuel dispenser options include hose orientation.

14. The system of claim 1, wherein said fuel dispenser options include more than one style of hose.

15. The system of claim 5, wherein said designs include a single-sided fuel dispenser or a dual-sided fuel dispenser.

16. The system of claim 5, wherein said designs include stickers.

17. The system of claim 5, wherein said designs include indicia.

18. The system of claim 5, wherein said designs include patterns.

19. The system of claim 5, wherein said designs can be located anywhere on said customized fuel dispenser.

20. The system of claim 2, wherein each of said at least one side of said customized fuel dispenser comprises the selection of at least one of said fuel dispenser option.

21. A system to customize a fuel dispenser comprising:
a computer;
a database of fuel dispenser options with said computer;
a selection means for selecting said fuel dispenser options from said database of said fuel dispenser options to create a customized fuel dispenser;
a display means for displaying said fuel dispenser options; and
a transfer means for transferring data with said computer comprising said customized fuel dispenser to a location for constructing said customized fuel dispenser.

22. The system of claim 21, wherein said customized fuel dispenser has at least one side and said fuel dispenser options are selected for each of said at least one side of said customized fuel dispenser.

23. The system of claim 21, wherein said fuel dispenser options are displayed as pull-down menus and pop-up menus.

24. The system of claim 21, wherein said fuel dispenser options include different colors for said customized fuel dispenser.

25. The system of claim 21, wherein said fuel dispenser options include designs for said customized fuel dispenser.

26. The system of claim 21, wherein said fuel dispenser options include different types of paint for said customized fuel dispenser.

27. The system of claim 21, wherein said fuel dispenser options include hose quantity.

28. The system of claim 21, wherein said fuel dispenser options include products to be dispensed from said customized fuel dispenser.

29. The system of claim 21, wherein said fuel dispenser options include positioning of said display means on said customized fuel dispenser.

30. The system of claim 21, wherein said transfer means is a modem.

31. The system of claim 21, wherein said display means displays current prices of said fuel dispenser options.

32. The system of claim 21, wherein said display means displays total cost of said customized fuel dispenser as said fuel dispensing options are selected.

33. The system of claim 21, wherein said fuel dispenser options include hose orientation.

34. The system of claim 21, wherein said fuel dispenser options include more than one style of hose.

35. The system of claim 25, wherein said designs include a single-sided fuel dispenser or a dual-sided fuel dispenser.

36. The system of claim 25, wherein said designs include stickers.

37. The system of claim 25, wherein said designs include indicia.

38. The system of claim 25, wherein said designs include patterns.

39. The system of claim 25, wherein said designs can be located anywhere on said customized fuel dispenser.

40. The system of claim 22, wherein each of said at least one side of said customized fuel dispenser comprises the selection of at least one of said fuel dispenser option.

41. A method of customizing a fuel dispenser comprising:
accessing a computer with a database of fuel dispenser options;
selecting said fuel dispenser options from said database of said fuel dispenser options to create a customized fuel dispenser;
displaying said fuel dispenser options;
saving data with said computer comprising said customized fuel dispenser; and
transferring data with said computer comprising said customized fuel dispenser to a location for constructing said customized fuel dispenser.

42. The method of claim 41, wherein said customized fuel dispenser has at least one side and said fuel dispenser options are selected for each of said at least one side of said customized fuel dispenser.

43. The method of claim 41, wherein said fuel dispenser options are displayed as pull-down menus and pop-up menus.

44. The method of claim 41, wherein said fuel dispenser options include different colors for said customized fuel dispenser.

45. The method of claim 41, wherein said fuel dispenser options include designs for said customized fuel dispenser.

46. The method of claim 41, wherein said fuel dispenser options include different types of paint for said customized fuel dispenser.

47. The method of claim 41, wherein said fuel dispenser options include hose quantity.

48. The method of claim 41, wherein said fuel dispenser options include products to be dispensed from said customized fuel dispenser.

49. The method of claim 41, wherein said fuel dispenser options include positioning of said display means on said customized fuel dispenser.

50. The method of claim 41, wherein said transfer means is a modem.

51. The method of claim 41, wherein said display means displays current prices of said fuel dispenser options.

52. The method of claim 41, wherein said display means displays total cost of said customized fuel dispenser as said fuel dispensing options are selected.

53. The method of claim 41, wherein said fuel dispenser options include hose orientation.

54. The method of claim 41, wherein said fuel dispenser options include more than one style of hose.

55. The method of claim 45, wherein said designs include a single-sided fuel dispenser or a dual-sided fuel dispenser.

56. The method of claim 45, wherein said designs include stickers.

57. The method of claim 45, wherein said designs include indicia.

58. The method of claim 45, wherein said designs include patterns.

59. The method of claim 45, wherein said designs can be located anywhere on said customized fuel dispenser.

60. The method of claim 42, wherein each of said at least one side of said customized fuel dispenser comprises the selection of at least one of said fuel dispenser option.

61. The system of claim 1, wherein said transfer means transfers said customized fuel dispenser to a different location for construction based on the number of customized fuel dispensers being constructed at the original location.
